(19) United States
(12) Patent Application Publication
(10) Pub. No.: US 2025/0108643 A1
(43) Pub. Date: Apr. 3, 2025

(54) PRINTING APPARATUS

(71) Applicant: Mitsubishi Electric Corporation, Chiyoda-ku, Tokyo (JP)

(72) Inventors: Takuma MIYAZAKI, Chiyoda-ku, Tokyo (JP); Kentaro MATSUI, Chiyoda-ku, Tokyo (JP); Gen TADA, Chiyoda-ku, Tokyo (JP)

(73) Assignee: Mitsubishi Electric Corporation, Chiyoda-ku, Tokyo (JP)

(21) Appl. No.: 18/833,269

(22) PCT Filed: Jan. 31, 2023
(86) PCT No.: PCT/JP2023/003021

§ 371 Date: Jul. 25, 2024

(30) Foreign Application Priority Data
Feb. 9, 2022 (JP) 2022-018457

(51) Int. Cl. B41J 25/308; B41J 3/28; B41J 11/00

(52) U.S. Cl. CPC B41J 25/308; B41J 3/286; B41J 11/007

(57) ABSTRACT

There is provided a reliable printing apparatus in which a distance between a printing head and a surface to be printed is kept constant. A printing apparatus according to the present disclosure includes: a printing head having a printing surface; a fixing unit connected to the printing head and having a fixing guide disposed along a first direction including the printing surface; a movable unit connected to the fixing unit, having a movable guide disposed along the first direction, and being movable with respect to the printing head along a second direction, the second direction intersecting with the first direction; a holding mechanism disposed on the movable unit and holding, along the first direction, an object to be printed that is printed by the printing head; and a vibration suppression unit disposed at an end of the movable unit and holding the object to be printed along the second direction.

### TECHNICAL FIELD

The present disclosure relates to a printing apparatus.

### BACKGROUND ART

Conventionally, there has been a printing apparatus that performs direct printing by a printing head of a printer on a surface to be printed, which is a side surface of a box-shaped object to be printed that is conveyed on a conveyance path. The printing apparatus is required to perform high-quality printing without human intervention.

For example, printing by a printing head is performed on a surface to be printed, in a state where an object to be printed is sandwiched between a pair of rollers disposed on both sides of the object to be printed.

### CITATION LIST

### Patent Literature

PTL 1: Japanese Patent Laying-Open No. 10-157245

### SUMMARY OF INVENTION

### Technical Problem

It is required that printing by a printing head should be performed on a surface to be printed, in a state where a distance between the printing head and the surface to be printed is kept constant. However, in a printing apparatus described in the publication above, a distance between a roller and a printing head is fixed. Therefore, a distance between a portion of a surface to be printed that is in contact with the roller and the printing head is fixed. Thus, when the flatness of the surface to be printed is low and the surface to be printed includes a flat plane and a protruding portion protruding from the flat plane toward the roller, a distance between the printing head and the flat plane is longer than a distance between the printing head and the protruding portion. Therefore, when the flatness of the surface to be printed is low, it is difficult to keep a distance between the printing head and the surface to be printed constant. In addition, due to vibration that occurs during conveyance of an object to be printed, it is difficult to keep the distance between the printing head and the surface to be printed constant.

The present disclosure has been made to solve the above-described problem, and an object thereof is to provide a printing apparatus in which a distance between a printing head and a surface to be printed can be kept constant.

### Solution to Problem

A printing apparatus according to the present disclosure includes: a printing head having a printing surface; a fixing unit connected to the printing head and having a fixing guide disposed along a first direction including the printing surface; a movable unit connected to the fixing unit, having a movable guide disposed along the first direction, and being movable with respect to the printing head along a second direction, the second direction intersecting with the first direction; a holding mechanism disposed on the movable unit and holding an object to be printed along the first direction, the object to be printed being an object on which printing by the printing head is performed; and a vibration suppression unit disposed at an end of the movable unit and holding the object to be printed along the second direction.

### Advantageous Effects of Invention

According to the present disclosure, since a surface to be printed is corrected into a planar shape and vibration of an object to be printed is suppressed, there can be provided a reliable printing apparatus in which a distance between a printing head and a surface to be printed is kept constant.

### BRIEF DESCRIPTION OF DRAWINGS

FIG. 1 is a front view schematically showing a state in which an object to be printed is disposed in front of a printing head of a printing apparatus according to a first embodiment.

FIG. 2 is a front view schematically showing a state in which the object to be printed is disposed laterally to the printing head of the printing apparatus according to the first embodiment.

FIG. 3 is a side view schematically showing an extended state of a holding device of the printing apparatus according to the first embodiment.

FIG. 4 is a side view schematically showing a contracted state of the holding device of the printing apparatus according to the first embodiment.

FIG. 5 is a side view schematically showing a state in which an object-to-be-printed pressing unit of the printing apparatus according to the first embodiment has pressed the object to be printed.

FIG. 6 is a side view schematically showing a state in which a conveyance reference unit of the printing apparatus according to the first embodiment has come into contact with the object to be printed.

FIG. 7 is a top view schematically showing an extended state of a first holding unit of the printing apparatus according to the first embodiment.

FIG. 8 is a top view schematically showing a contracted state of the first holding unit of the printing apparatus according to the first embodiment.

FIG. 9 is a bottom view schematically showing an extended state of a second holding unit of the printing apparatus according to the first embodiment.

FIG. 10 is a bottom view schematically showing a contracted state of the second holding unit of the printing apparatus according to the first embodiment.

FIG. 11 is a front view schematically showing a configuration of a fixing unit of the printing apparatus according to the first embodiment.

FIG. 12 is a side view schematically showing the configuration of the fixing unit of the printing apparatus according to the first embodiment.

FIG. 13 is a top view schematically showing the configuration of the fixing unit of the printing apparatus according to the first embodiment.

FIG. 14 is a front view schematically showing a configuration of a movable unit of the printing apparatus according to the first embodiment.

FIG. 15 is a side view schematically showing the configuration of the movable unit of the printing apparatus according to the first embodiment.

FIG. 16 is a top view schematically showing the configuration of the movable unit of the printing apparatus according to the first embodiment.

FIG. 17 is a front view schematically showing a state in which an object to be printed is disposed in front of a printing head of a printing apparatus according to a second embodiment.

FIG. 18 is a front view schematically showing a state in which the object to be printed is disposed laterally to the printing head of the printing apparatus according to the second embodiment.

FIG. 19 is a side view schematically showing a configuration of the printing apparatus according to the second embodiment.

FIG. 20 is a top view schematically showing the state in which the object to be printed is disposed in front of the printing head of the printing apparatus according to the second embodiment.

FIG. 21 is a top view schematically showing the state in which the object to be printed is disposed laterally to the printing head of the printing apparatus according to the second embodiment.

FIG. 22 schematically shows an operation procedure of the printing apparatus according to the second embodiment.

### DESCRIPTION OF EMBODIMENTS

Embodiments will be described hereinafter with reference to the drawings. In the following description, the same or corresponding portions are denoted by the same reference characters and redundant description will not be repeated.

### First Embodiment

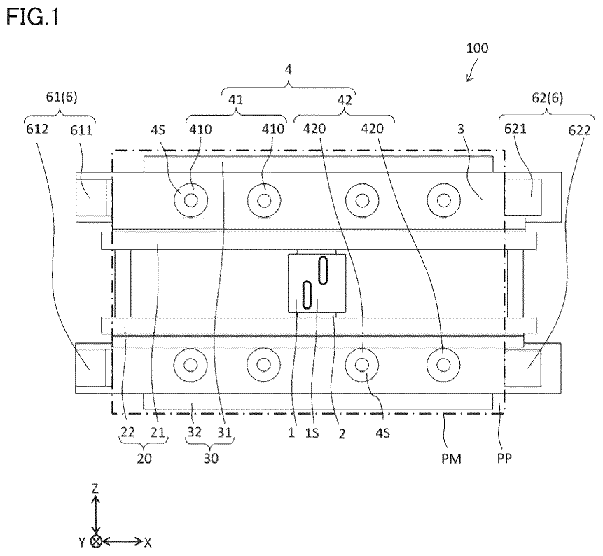

As shown in FIG. 1, a printing apparatus 100 is a printing apparatus for performing printing on a surface to be printed PP of an object to be printed PM. For convenience in description, an outer shape of object to be printed PM is indicated by a one-dot chain line in FIG. 1. Surface to be printed PP is one surface of object to be printed PM. Printing apparatus 100 includes a printing head 1, a fixing unit 2 and a movable unit 3. Printing head 1 includes a printing surface 1S. Printing head 1 can perform printing on surface to be printed PP. Printing surface 1S is configured to be capable of performing printing. Printing surface 1S is configured to face surface to be printed PP. An ink or the like is applied onto surface to be printed PP by printing surface 1S, thereby performing printing on surface to be printed PP. Printing head 1 is, for example, an ink jet-type printing head.

Printing head 1 is connected to fixing unit 2. In the present embodiment, printing head 1 is fixed to fixing unit 2. Fixing unit 2 includes a fixing guide 20. Fixing guide 20 and printing surface 1S are arranged along a first direction (Z-axis direction). In the present embodiment, fixing guide 20 includes a first fixing guide unit 21 and a second fixing guide unit 22. First fixing guide unit 21 and second fixing guide unit 22 are disposed to sandwich printing head 1 along the first direction (Z-axis direction).

In the present embodiment, the first direction (Z-axis direction) refers to a direction in which fixing guide 20 and a movable guide 30 are arranged. A second direction (X-axis direction) refers to a direction intersecting with the first direction (Z-axis direction). The second direction (X-axis direction) is preferably orthogonal to the first direction (Z-axis direction). A third direction (Y-axis direction) refers to a direction in which printing surface 1S of printing head 1 and surface to be printed PP face each other. The third direction (Y-axis direction) refers to a direction intersecting with each of the first direction (Z-axis direction) and the second direction (X-axis direction). The third direction (Y-axis direction) is preferably orthogonal to each of the first direction (Z-axis direction) and the second direction (X-axis direction).

In the present embodiment, the X-axis direction is a direction along the second direction. The Y-axis direction is a direction along the third direction. The Z-axis direction is a direction along the first direction.

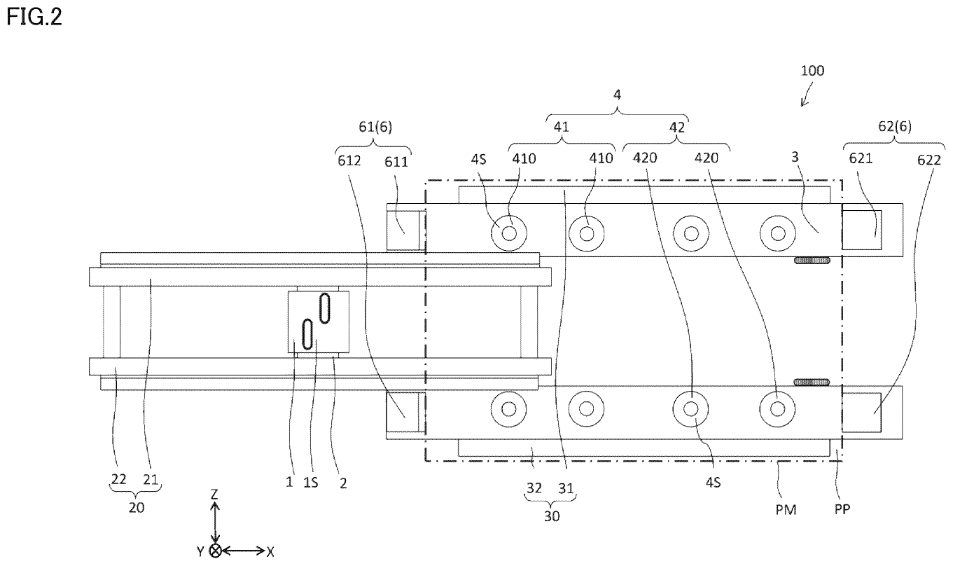

Movable unit 3 is connected to fixing unit 2. Movable unit 3 includes a movable guide 30, a holding mechanism 4 and a vibration suppression unit 6. Movable guide 30 and fixing guide 20 are arranged along the first direction (Z-axis direction). As shown in FIGS. 1 and 2, movable guide 30 is configured to be movable with respect to printing head 1 along the second direction (X-axis direction) intersecting with the first direction (Z-axis direction). Therefore, movable guide 30 is configured to be movable with respect to fixing guide 20 along the second direction (X-axis direction).

In the present embodiment, movable guide 30 includes a first movable guide unit 31 and a second movable guide unit 32. First movable guide unit 31 is disposed opposite to printing head 1 with respect to first fixing guide unit 21. Second movable guide unit 32 is disposed opposite to printing head 1 with respect to second fixing guide unit 22. First movable guide unit 31 and second movable guide unit 32 are arranged along the first direction (Z-axis direction). First movable guide unit 31 and second movable guide unit 32 are disposed to sandwich printing head 1 along the first direction (Z-axis direction).

Holding mechanism 4 is disposed between fixing guide 20 and movable guide 30 along the first direction (Z-axis direction). Holding mechanism 4 is disposed opposite to printing head 1 with respect to fixing guide 20.

Holding mechanism 4 includes an end face 4S. End face 4S of holding mechanism 4 is configured to hold surface to be printed PP, which is one surface of object to be printed PM. Specifically, in the present embodiment, end face 4S of holding mechanism 4 is configured to hold surface to be printed PP by adsorbing surface to be printed PP. Although FIGS. 1, 2 and the like illustrate end face 4S of holding mechanism 4 configured to hold surface to be printed PP by adsorbing surface to be printed PP, end face 4S of holding mechanism 4 is not limited to this configuration, as long as end face 4S of holding mechanism 4 can hold surface to be printed PP. For example, when object to be printed PM is a magnetic member such as an iron plate, end face 4S of holding mechanism 4 may be configured to hold surface to be printed PP by magnetic force.

Holding mechanism 4 includes a first holding unit 41 and a second holding unit 42. First holding unit 41 is disposed between first fixing guide unit 21 and first movable guide unit 31 along the first direction (Z-axis direction). Second holding unit 42 is disposed between second fixing guide unit 22 and second movable guide unit 32 along the first direction (Z-axis direction). Therefore, first holding unit 41 and second holding unit 42 are disposed to sandwich printing head 1 along the first direction (Z-axis direction).

Vibration suppression unit 6 is disposed between fixing guide 20 and movable guide 30 along the first direction (Z-axis direction). Vibration suppression unit 6 is disposed opposite to printing head 1 with respect to fixing guide 20.

Vibration suppression unit 6 includes a reference unit 61 and a pressing unit 62. Reference unit 61 includes a first reference unit 611 and a second reference unit 612. First reference unit 611 is disposed between first fixing guide unit 21 and first movable guide unit 31 along the first direction (Z-axis direction). Second reference unit 612 is disposed between second fixing guide unit 22 and second movable guide unit 32 along the first direction (Z-axis direction). Pressing unit 62 includes a first pressing unit 621 and a second pressing unit 622. First pressing unit 621 is disposed between first fixing guide unit 21 and first movable guide unit 31 along the first direction (Z-axis direction). Second pressing unit 622 is disposed between second fixing guide unit 22 and second movable guide unit 32 along the first direction (Z-axis direction). Therefore, reference unit 61 and pressing unit 62 are disposed to sandwich printing head 1 along the first direction (Z-axis direction).

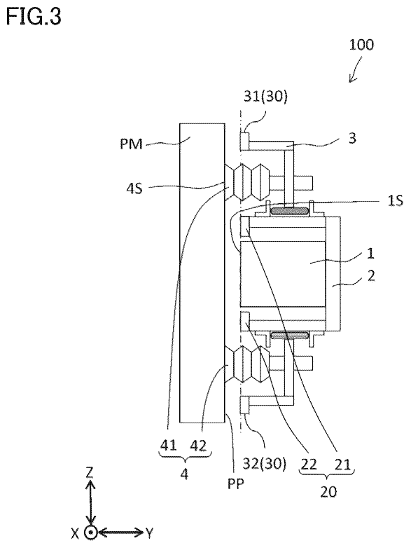

As shown in FIG. 3, printing surface 1S of printing head 1 faces surface to be printed PP. Printing surface 1S of printing head 1 is disposed in parallel with surface to be printed PP. Printing surface 1S extends along each of the first direction (Z-axis direction) and the second direction (X-axis direction).

A position of fixing guide 20 in the third direction (Y-axis direction) and a position of movable guide 30 in the third direction (Y-axis direction) are preferably the same. A position of printing surface 1S in the third direction (Y-axis direction) is a position that is rearward of fixing guide 20 and movable guide 30 or a position that is the same as fixing guide 20 and movable guide 30.

Although object to be printed PM has a rectangular parallelepiped shape in the present embodiment, the shape of object to be printed PM is not limited to the rectangular parallelepiped shape, as long as surface to be printed PP has a planar shape.

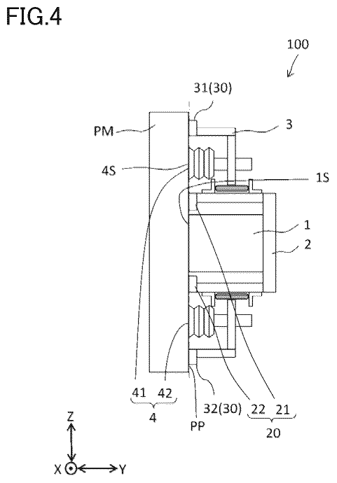

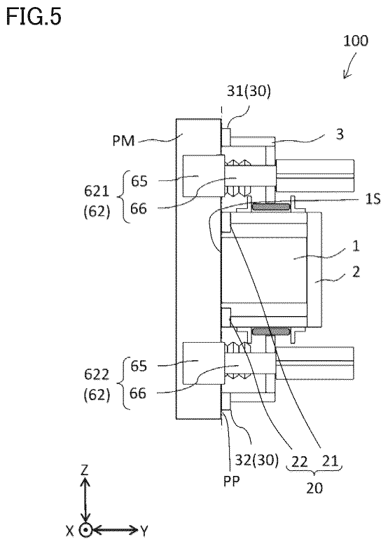

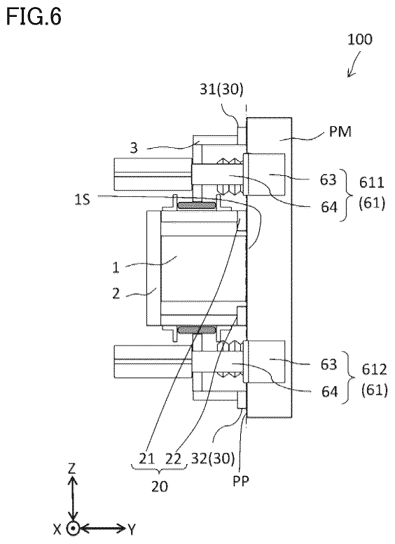

As shown in FIGS. 3 and 4, holding mechanism 4 is configured to be capable of moving end face 4S along the third direction (Y-axis direction) intersecting with each of the first direction (Z-axis direction) and the second direction (X-axis direction). End face 4S of holding mechanism 4 is configured to be movable from the front of fixing guide 20 and movable guide 30 to fixing guide 20 and movable guide 30 along the third direction (Y-axis direction). FIG. 5 is a side view schematically showing a state in which pressing unit 62 has pressed object to be printed PM, and FIG. 6 is a side view schematically showing a state in which reference unit 61 has come into contact with the object to be printed.

In the present embodiment, each of first holding unit 41 and second holding unit 42 is provided with end face 4S. Each of first holding unit 41 and second holding unit 42 is configured to be capable of moving end face 4S along the third direction (Y-axis direction).

Holding mechanism 4 is configured to be capable of moving surface to be printed PP from the front of fixing guide 20 and movable guide 30 to fixing guide 20 and movable guide 30 along the third direction (Y-axis direction) in a state where end face 4S is holding surface to be printed PP. Holding mechanism 4 is configured to be capable of moving surface to be printed PP from the front of printing head 1 to printing head 1 along the third direction (Y-axis direction) in the state where end face 4S is holding surface to be printed PP.

In the present embodiment, holding mechanism 4 is configured to be capable of moving end face 4S by being extended and contracted along the third direction (Y-axis direction). Although holding mechanism 4 is configured to be movable by being extended and contracted in the present embodiment, a method of movement of holding mechanism 4 is not limited to extension and contraction. For example, holding mechanism 4 may move by sliding of the whole of holding mechanism 4.

In an extended state of holding mechanism 4, surface to be printed PP is disposed away from printing surface 1S of printing head 1. In a contracted state of holding mechanism 4, it is desirable that surface to be printed PP should be in contact with printing surface 1S of printing head 1. In the contracted state of holding mechanism 4, surface to be printed PP may be spaced apart from printing surface 1S of printing head 1. In order to achieve high-quality printing, it is required that an interval between surface to be printed PP and printing surface 1S of printing head 1 should be constant during printing and variations in interval should be small. The interval between surface to be printed PP and printing surface 1S of printing head 1 is, for example, equal to or less than 3 mm.

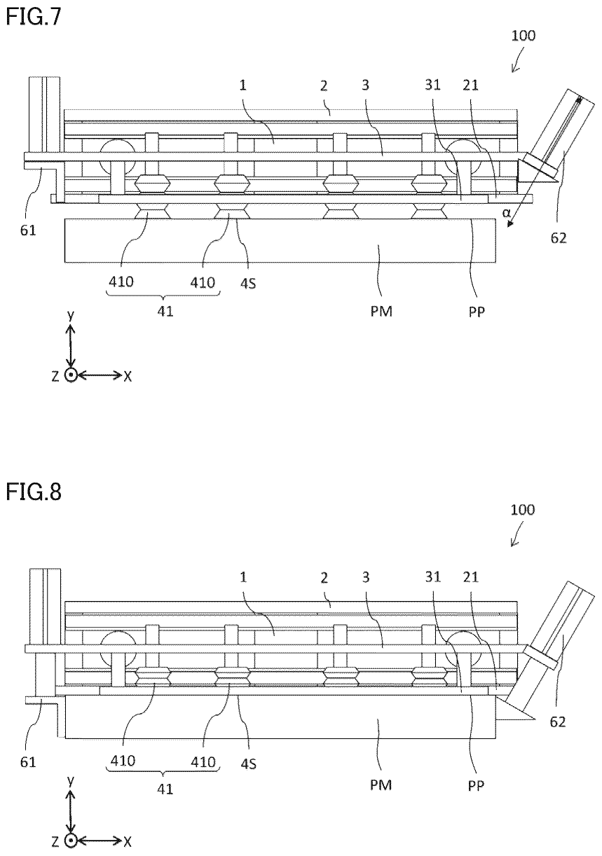

As shown in FIG. 7, first holding unit 41 includes a plurality of first holding parts 410. Each of the plurality of first holding parts 410 is provided with end face 4S. The plurality of first holding parts 410 are arranged along the second direction (X-axis direction). As shown in FIGS. 7 and 8, each of the plurality of first holding parts 410 is configured to be capable of moving end face 4S from the front of fixing guide 20 and movable guide 30 to fixing guide 20 and movable guide 30 along the third direction (Y-axis direction). As shown in FIG. 8, reference unit 61 has come into contact with the object to be printed, and pressing unit 62 has pressed object to be printed PM.

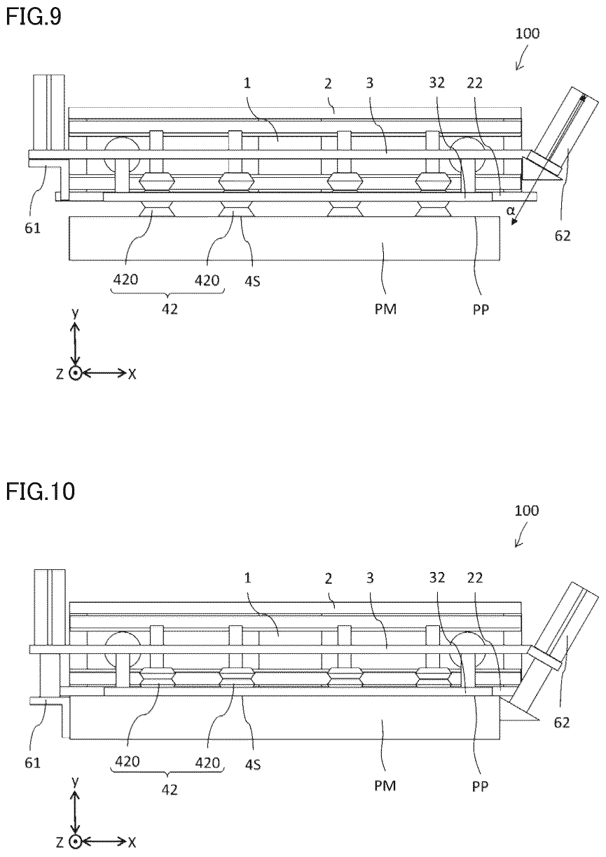

As shown in FIG. 9, second holding unit 42 includes a plurality of second holding parts 420. Each of the plurality of second holding parts 420 is provided with end face 4S. The plurality of second holding parts 420 are arranged along the second direction (X-axis direction). As shown in FIGS. 9 and 10, each of the plurality of second holding parts 420 is configured to be capable of moving end face 4S from the front of fixing guide 20 and movable guide 30 to fixing guide 20 and movable guide 30 along the third direction (Y-axis direction).

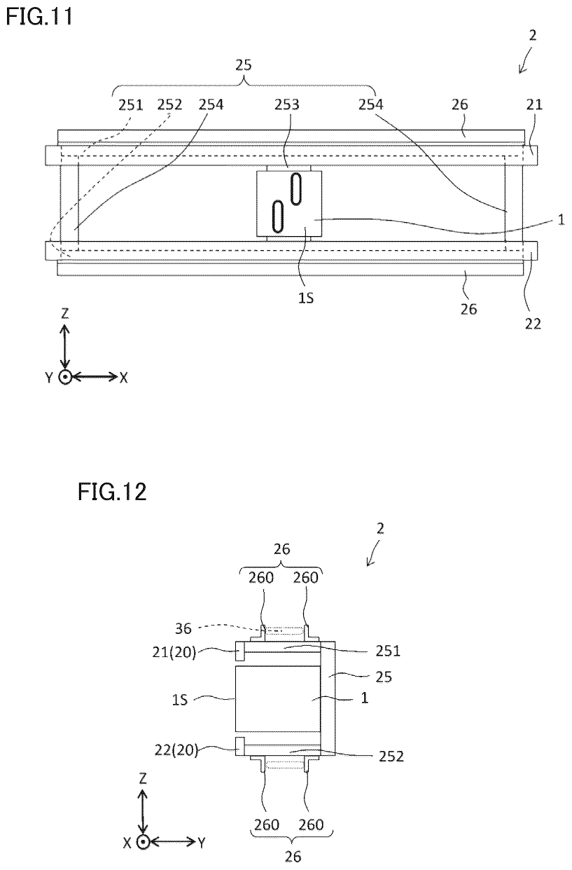

A configuration of fixing unit 2 according to the first embodiment will now be described in detail with reference to FIGS. 11 to 13.

As shown in FIG. 11, fixing unit 2 further includes an attachment unit 25 and a rail unit 26. Attachment unit 25 includes a first flat plate portion 251, a second flat plate portion 252, a center support portion 253, and a pair of end support portions 254. First flat plate portion 251 and second flat plate portion 252 are disposed away from each other along the first direction (Z-axis direction). Each of first flat plate portion 251 and second flat plate portion 252 has a flat plate shape. First fixing guide unit 21 is fixed to first flat plate portion 251. Second fixing guide unit 22 is fixed to second flat plate portion 252. Second flat plate portion 252 is fixed to first flat plate portion 251 by center support portion 253 and the pair of end support portions 254. Printing head 1 is fixed to center support portion 253. A dimension of center support portion 253 along the second direction (X-axis direction) is larger than a dimension of the pair of end support portions 254. The pair of end support portions 254 are disposed at both ends of each of first flat plate portion 251 and second flat plate portion 252, respectively. Each of the pair of end support portions 254 is, for example, a square rod.

Object to be printed PM travels along the second direction (X-axis direction), in a state where first fixing guide unit 21 is in contact with surface to be printed PP and second fixing guide unit 22 is in contact with surface to be printed PP. In order to achieve high-quality printing, it is required that fluctuations in speed in the second direction (X-axis direction), which is a conveyance direction of object to be printed PM, should not occur. It is desirable that a member having a low coefficient of friction with surface to be printed PP of object to be printed PM should be used as each of first fixing guide unit 21 and second fixing guide unit 22 so as to prevent fluctuations in speed caused by stick slip.

As shown in FIG. 12, printing head 1, fixing guide 20 and rail unit 26 are attached to attachment unit 25. In the present embodiment, a surface of printing head 1 opposite to printing surface 1S is fixed to attachment unit 25. The rigidity of attachment unit 25 is high to such an extent that attachment unit 25 is not deformed in a state where printing head 1, fixing guide 20 and rail unit 26 are attached to attachment unit 25.

In the present embodiment, rail unit 26 includes a pair of L-shaped members 260 that face each other. The pair of L-shaped members 260 are spaced apart from each other. An interval between the pair of L-shaped members 260 is equal to or more than an outer diameter of a rotating unit 36 described below. In FIG. 12, an outer shape of rotating unit 36 is indicated by a broken line. Therefore, rotating unit 36 can move between the pair of L-shaped members 260 while rotating. Rail unit 26 has a strength to such an extent that rail unit 26 is not deformed even when rotating unit 36 comes into contact with rail unit 26. Rail unit 26 has a low coefficient of friction to such an extent that rotating unit 36 having come into contact with rail unit 26 can move along rail unit 26. It is desirable that the interval between the pair of L-shaped members 260 should be adjustable when the pair of L-shaped members 260 are attached to attachment unit 25. Alternatively, the accuracy of the movement direction may be secured by providing a linear motion guide such as, for example, an LM guide, not the rotation function.

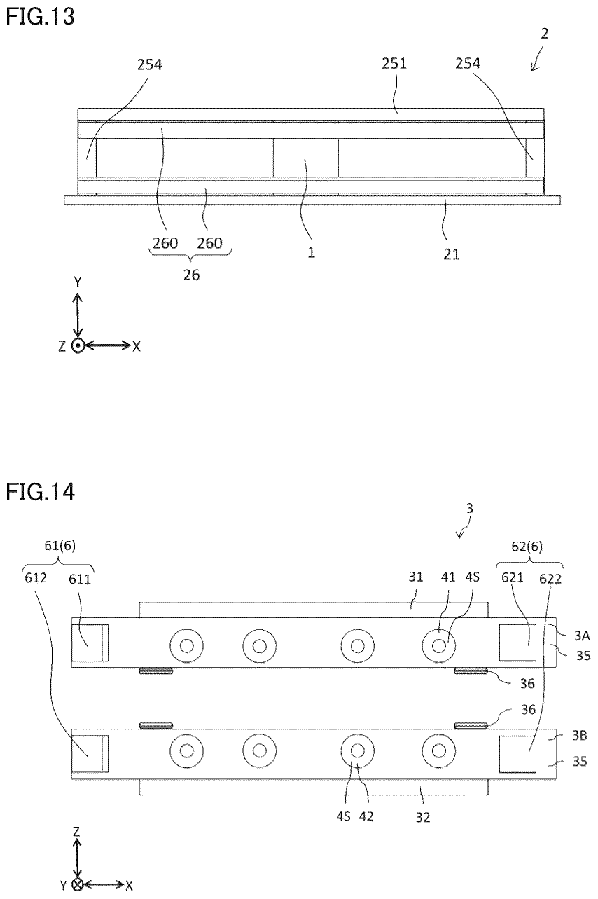

As shown in FIG. 13, rail unit 26 is attached to the pair of end support portions 254. Rail unit 26 extends along the X-axis direction. The longitudinal direction of rail unit 26 is parallel to surface to be printed PP (see FIG. 3).

A configuration of movable unit 3 according to the first embodiment will now be described in detail with reference to FIGS. 14 to 16.

As shown in FIG. 14, movable unit 3 includes a first movable unit 3A and a second movable unit 3B. First movable unit 3A and second movable unit 3B are arranged along the first direction (Z-axis direction). First movable unit 3A includes first movable guide unit 31. Second movable unit 3B includes second movable guide unit 32. In the present embodiment, first movable unit 3A and second movable unit 3B are disposed line-symmetrically.

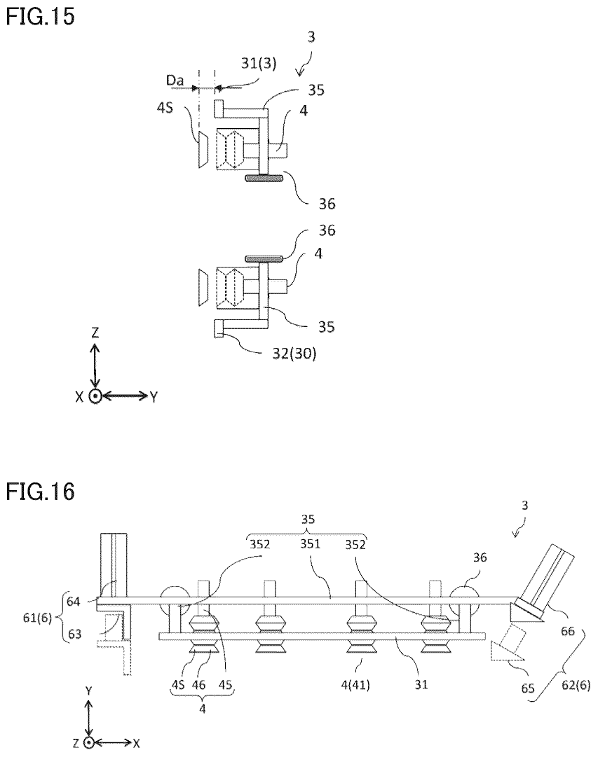

As shown in FIG. 15, movable unit 3 further includes a pad plate unit 35 and rotating unit 36. Movable guide 30, holding mechanism 4, vibration suppression unit 6, and rotating unit 36 are attached to pad plate unit 35. The rigidity of pad plate unit 35 is high to such an extent that pad plate unit 35 is not deformed even when movable guide 30, holding mechanism 4 and rotating unit 36 are attached to pad plate unit 35.

Movable guide 30 is attached to pad plate unit 35. Movable guide 30 has a flat plate shape parallel to surface to be printed PP. Therefore, movable guide 30 does not have undulations. In addition, movable guide 30 has a strength to such an extent that movable guide 30 is not deformed even when surface to be printed PP is pressed against movable guide 30.

In FIG. 15, an outer shape of a tip of holding mechanism 4 in the extended state is indicated by a solid line. An outer shape of holding mechanism 4 in the contracted state is indicated by a broken line. A distance of movement of the holding mechanism by being extended and contracted is indicated by a distance Da.

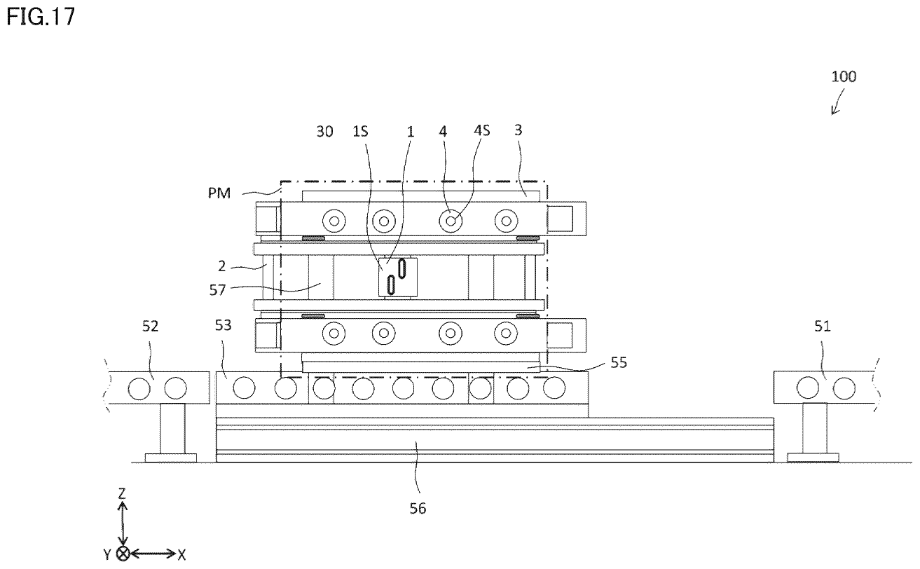

As shown in FIG. 16, in the present embodiment, pad plate unit 35 includes a movable-side first portion 351 and a plurality of movable-side second portions 352. Movable-side first portion 351 has a flat plate shape. The plurality of movable-side second portions 352 connect movable-side first portion 351 and movable guide 30. Each of the plurality of movable-side second portions 352 is orthogonally connected to movable-side first portion 351. The plurality of movable-side second portions 352 are fixed to movable-side first portion 351. Each of the plurality of movable-side second portions 352 is, for example, a square rod. In the present embodiment, pad plate unit 35 includes two movable-side second portions 352.

Rotating unit 36 has a disc shape. Rotating unit 36 is configured to be rotatable around the Z axis. Rotating unit 36 is connected so as to be orthogonal to pad plate unit 35. Rotating unit 36 is rotatable with respect to pad plate unit 35. Rotating unit 36 may have a not-shown bearing built thereinto. As a result, the rotation accuracy of rotating unit 36 is improved. Alternatively, rotating unit 36 may be configured to automatically rotate by a not-shown drive mechanism. Rotating unit 36 rotates in rail unit 26 (see FIG. 12), which causes movable unit 3 to move with respect to fixing unit 2.

Holding mechanism 4 includes a pad unit 46 and a shaft unit 45. Shaft unit 45 is connected to pad plate unit 35 so as to be orthogonal to pad plate unit 35. Pad unit 46 is supported by shaft unit 45. Pad unit 46 is configured to hold surface to be printed PP (see FIG. 3). Specifically, in the present embodiment, pad unit 46 is configured to adsorb surface to be printed PP (see FIG. 3) by vacuum adsorption. As a result, holding mechanism 4 holds surface to be printed PP. When object to be printed PM (see FIG. 3) is a magnetic member such as an iron plate, pad unit 46 may be configured to hold surface to be printed PP (see FIG. 3) by magnetic force. Pad unit 46 is an elastic member that can be extended and contracted. Pad unit 46 is, for example, an elastic member that is extended and contracted by bellows. Pad unit 46 is configured not to damage surface to be printed PP when pad unit 46 comes into contact with surface to be printed PP. Pad unit 46 has a sufficient strength to avoid breakage when being pressed against surface to be printed PP. Pad unit 46 has a sufficient thickness to avoid breakage when being pressed against surface to be printed PP. A material of pad unit 46 has a sufficient strength to avoid breakage when pad unit 46 is pressed against surface to be printed PP. In the present embodiment, end face 4S is provided on pad unit 46.

Reference unit 61 includes an abutting unit 63 and a shaft unit 64. Shaft unit 64 is connected to pad plate unit 35 so as to be orthogonal to pad plate unit 35. Abutting unit 63 is connected to shaft unit 64 and is configured such that shaft unit 64 itself can move in the third direction (Y-axis direction). Abutting unit 63 is configured to abut on a side surface of object to be printed PM. Specifically, in the present embodiment, abutting unit 63 is configured to abut on the side surface of object to be printed PM in a surface contact manner when object to be printed PM is held by holding mechanism 4. As a result, printing is performed in a state where abutting unit 63 is in contact with object to be printed PM when object to be printed PM moves along the second direction (X-axis direction), which is the conveyance direction of object to be printed PM. Shaft unit 64 has an amount of movement equal to or larger than an amount of extension and contraction of pad unit 46. Abutting unit 63 is made of a material that does not damage object to be printed PM.

Pressing unit 62 includes an abutting unit 65 and a shaft unit 66. Shaft unit 66 is connected to pad plate unit 35 at an angle such that shaft unit 66 faces a fourth direction (a-axis direction) with respect to pad plate unit 35. Abutting unit 65 is made of a material that does not damage object to be printed PM. Abutting unit 65 is connected to shaft unit 66 and is configured such that shaft unit 64 itself can move in the fourth direction (a-axis direction). Abutting unit 65 is configured to press the side surface of object to be printed PM. Specifically, in the present embodiment, abutting unit 65 presses object to be printed PM toward the conveyance reference unit 61 side, in a state where conveyance reference unit 61 abuts on the side surface of object to be printed PM in a surface contact manner, when object to be printed PM is held by holding mechanism 4. As a result, object to be printed PM is sandwiched between conveyance reference unit 61 and pressing unit 62 in the second direction (X-axis direction), which is the conveyance direction. When movable unit 3 can move with respect to fixing unit 2, object to be printed PM is sandwiched in the second direction (X-axis direction), so that fluctuations in speed in the conveyance direction become less likely to occur.

A printing method by printing apparatus 100 according to the first embodiment will now be described with reference to FIGS. 1 to 4.

As shown in FIG. 2, movable unit 3 is moved to rail unit 26 of fixing unit 2 by a not-shown conveyance device, in the state where end face 4S is holding surface to be printed PP of object to be printed PM. Rotating unit 36 rotates along rail unit 26, which causes movable unit 3 to move with respect to fixing unit 2. The movement direction of movable unit 3 is orthogonal to surface to be printed PP.

Next, as shown in FIGS. 3 and 4, end face 4S of holding mechanism 4 moves from the front of fixing guide 20 and movable guide 30 to fixing guide 20 and movable guide 30 along the third direction (Y-axis direction) in the state where end face 4S is holding surface to be printed PP. As a result, surface to be printed PP comes into contact with fixing guide 20 and movable guide 30. Thus, even when surface to be printed PP has projections and recesses, surface to be printed PP is deformed to follow fixing guide 20 and movable guide 30, and thus, surface to be printed PP is corrected into a planar shape.

Next, as shown in FIGS. 1 and 4, reference unit 61 and pressing unit 62 of vibration suppression unit 6 move to the object to be printed PM side, whereby reference unit 61 and pressing unit 62 sandwich object to be printed PM along the third direction (Y-axis direction). As a result, even when vibration or shaking occurs in object to be printed PM depending on a condition of a conveyance manner by the not-shown conveyance device, fluctuations in speed do not occur in surface to be printed PP because surface to be printed PP is conveyed in synchronization with holding mechanism 4.

Next, as shown in FIGS. 1 and 4, movable unit 3 moves along the second direction (X-axis direction) in a state where surface to be printed PP is in contact with fixing guide 20 and movable guide 30. As a result, the printing start position of surface to be printed PP moves to a position that faces printing surface 1S of printing head 1. Surface to be printed PP faces printing surface 1S of printing head 1 in parallel.

Printing surface 1S of printing head 1 performs printing on surface to be printed PP in a state where printing surface 1S faces surface to be printed PP. Movable unit 3 moves along the second direction (X-axis direction) in a state where printing by printing surface 1S is being performed on surface to be printed PP. When printing is performed on surface to be printed PP until the printing end position of surface to be printed PP is reached, printing ends.

After printing ends, end face 4S of holding mechanism 4 moves from fixing guide 20 and movable guide 30 to the front of fixing guide 20 and movable guide 30 along the third direction (Y-axis direction) in the state where end face 4S is holding surface to be printed PP. As a result, surface to be printed PP moves away from printing head 1. Specifically, the pad of holding mechanism 4 is extended, whereby end face 4S of holding mechanism 4 moves. Surface to be printed PP may move away from printing head 1 after rotating unit 36 (see FIG. 2) moves away from rail unit 26 (see FIG. 2).

The function and effect of the present embodiment will now be described.

Printing apparatus 100 according to the first embodiment includes: printing head 1 having printing surface 1S; fixing unit 2 connected to printing head 1 and having fixing guide 20 disposed along the first direction including printing surface 1S; movable unit 3 connected to fixing unit 2, having movable guide 30 disposed along the first direction, and being movable with respect to printing head 1 along the second direction, the second direction intersecting with the first direction; holding mechanism 4 disposed on movable unit 3 and holding the object to be printed along the first direction, the object to be printed being an object on which printing by printing head 1 is performed; and vibration suppression units 61 and 62 disposed at ends of movable unit 3 and holding the object to be printed along the second direction. Therefore, holding mechanism 4 can move surface to be printed PP held by end face 4S to fixing guide 20 and movable guide 30. As a result, surface to be printed PP comes into contact with fixing guide 20 and movable guide 30. Even when the flatness of surface to be printed PP is low, surface to be printed PP is corrected into a planar shape and vibration of the object to be printed is suppressed, because surface to be printed PP comes into contact with fixing guide 20 and movable guide 30. Therefore, a distance between fixing guide 20 and movable guide 30 and surface to be printed PP can be kept constant. Thus, there can be provided a reliable printing apparatus in which a distance between printing head 1 and surface to be printed PP is kept constant.

If the distance between printing head 1 and surface to be printed PP is no longer constant and thus increases, fading of printing occurs. In addition, the printing concentration decreases. According to the present embodiment, the distance between printing head 1 and surface to be printed PP can be kept constant. As a result, the occurrence of fading of printing can be suppressed. In addition, the decrease in printing concentration can be suppressed.

As shown in FIG. 3, printing head 1 is fixed to fixing unit 2. Therefore, printing head 1 does not move with respect to fixing unit 2. Movable unit 3 moves with respect to fixing unit 2. Therefore, the occurrence of vibration in printing head 1 due to movement of printing head 1 can be suppressed. Thus, the occurrence of damage such as clogging of an ink caused by vibration can be suppressed.

As shown in FIGS. 3 and 4, holding mechanism 4 is configured to be movable by being extended and contracted along the third direction (Y-axis direction). Therefore, shock caused when surface to be printed PP comes into contact with fixing guide 20 and movable guide 30 can be mitigated by extension and contraction of holding mechanism 4.

As shown in FIGS. 3 and 4, first holding unit 41 is disposed between first fixing guide unit 21 and first movable guide unit 31 along the first direction (Z-axis direction). Second holding unit 42 is disposed between second fixing guide unit 22 and second movable guide unit 32 along the first direction (Z-axis direction). Therefore, first holding unit 41 and second holding unit 42 sandwich printing head 1 along the first direction (Z-axis direction). Thus, surface to be printed PP held by first holding unit 41 and second holding unit 42 comes into contact with fixing guide 20 and movable guide 30 on both sides of printing head 1 along the first direction (Z-axis direction), whereby surface to be printed PP is corrected into a planar shape. As a result, surface to be printed PP becomes more parallel to printing surface 1S of printing head 1 along the first direction (Z-axis direction), as compared with when surface to be printed PP comes into contact with fixing guide 20 and movable guide 30 only on one side of printing head 1, whereby surface to be printed PP is corrected into a planar shape. Therefore, printing can be performed on surface to be printed PP in a state where the distance between surface to be printed PP and printing head 1 along the first direction (Z-axis direction) is kept constant.

As shown in FIG. 1, the plurality of first holding parts 410 are arranged along the second direction (X-axis direction). The plurality of second holding parts 420 are arranged along the second direction (X-axis direction). Therefore, surface to be printed PP is held by the plurality of first holding parts 410 and the plurality of second holding parts 420 arranged along the second direction (X-axis direction). Thus, surface to be printed PP comes into contact with fixing guide 20 and movable guide 30 at a plurality of locations arranged along the second direction (X-axis direction), whereby surface to be printed PP is corrected into a planar shape. As a result, surface to be printed PP becomes more parallel to printing surface 1S of printing head 1 along the second direction (X-axis direction), as compared with when surface to be printed PP comes into contact with fixing guide 20 and movable guide 30 at one location. Therefore, printing can be performed on surface to be printed PP in a state where the distance between surface to be printed PP and printing head 1 along the second direction (X-axis direction) is kept constant.

As shown in FIG. 2, vibration suppression units 6 are configured to sandwich the opposing planar surfaces of object to be printed PP. Therefore, even when surface to be printed PP of object to be printed PM is located at a position higher than that of the conveyance device, object to be printed PM can be held regardless of a positioning method on the conveyance device side.

As shown in FIG. 10, rotating unit 36 is configured to move between L-shaped members 260 of rail unit 26. Therefore, a movement error of rotating unit 36 along the third direction (Y-axis direction) is equal to or less than a difference between the interval between L-shaped members 260 and the outer diameter of rotating unit 36. Thus, the distance between printing head 1 and surface to be printed PP can be set to be equal to or less than the distance between the interval between L-shaped members 260 and the outer diameter of rotating unit 36.

### Second Embodiment

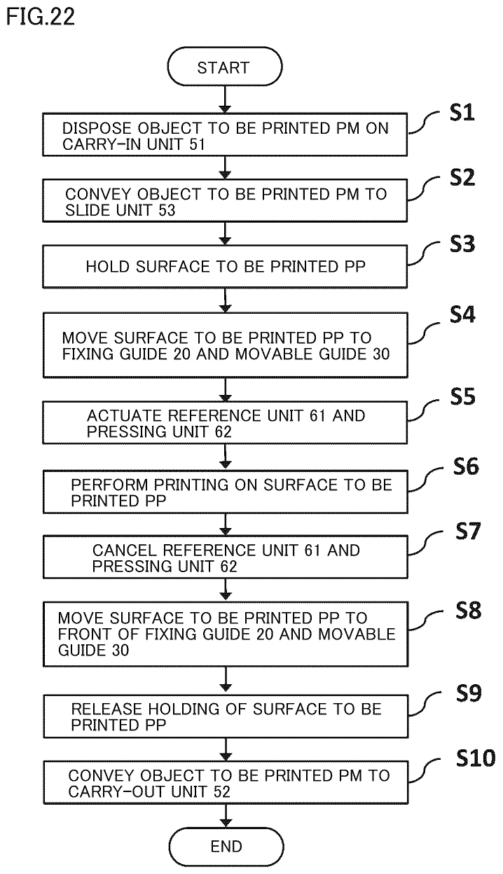

A configuration of printing apparatus 100 according to a second embodiment will now be described with reference to FIGS. 17 to 22. The second embodiment has the same configuration and function and effect as those of the above-described first embodiment unless otherwise specified. Therefore, the same components as those of the above-described first embodiment are denoted by the same reference characters and description thereof will not be repeated.

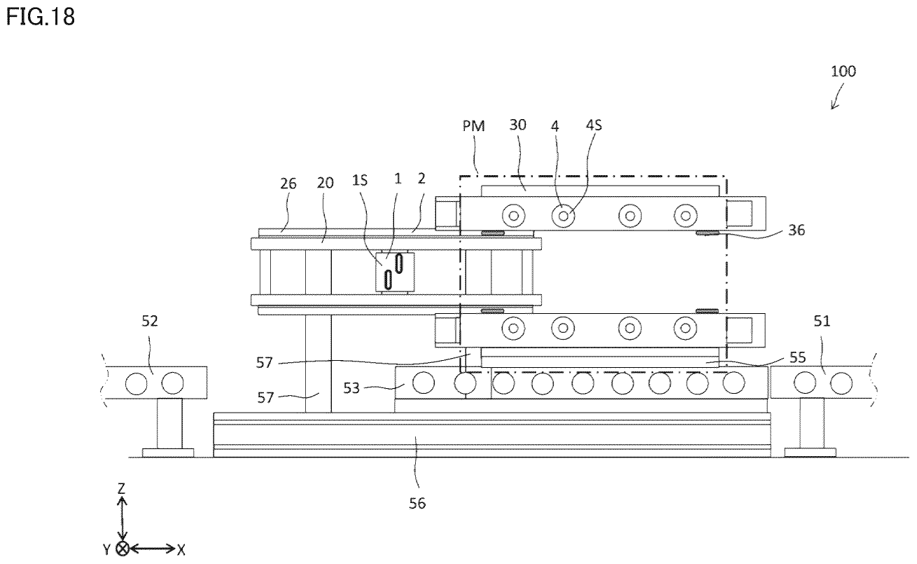

As shown in FIG. 17, printing apparatus 100 according to the second embodiment further includes a carry-in unit 51, an carry-out unit 52, a slide unit 53, a connection unit 55, a pedestal unit 56, and a pillar unit 57. Object to be printed PM is conveyed from carry-in unit 51 through slide unit 53 to carry-out unit 52. In FIGS. 17 and 18, an outer shape of object to be printed PM is indicated by a one-dot chain line.

As shown in FIGS. 17 and 18, carry-in unit 51 can convey object to be printed PM to movable unit 3. Carry-in unit 51 can convey object to be printed PM toward carry-out unit 52. Movable unit 3 is disposed between carry-in unit 51 and carry-out unit 52. Movable unit 3 can convey object to be printed PM that has been conveyed by carry-in unit 51. Movable unit 3 is configured to be capable of reciprocating between carry-in unit 51 and carry-out unit 52. Carry-out unit 52 can receive object to be printed PM that has been conveyed by movable unit 3.

In the present embodiment, each of carry-in unit 51 and carry-out unit 52 is configured as a roller conveyor. Each of carry-in unit 51 and carry-out unit 52 may, for example, be configured as an automated guided vehicle (AGV), a hand truck and the like as long as it can convey object to be printed PM.

In the present embodiment, each of carry-in unit 51 and carry-out unit 52 is fixed to an installation surface. A conveyance method including a ceiling-hanging conveyance method such as a floorboard-lifted turret may be used as a method for conveyance by carry-in unit 51 and carry-out unit 52.

Slide unit 53 is disposed between carry-in unit 51 and carry-out unit 52. Object to be printed PM is placed on slide unit 53.

Connection unit 55 is disposed on slide unit 53. Connection unit 55 connects slide unit 53 and movable unit 3. As a result, movable unit 3 is movable together with slide unit 53.

Pedestal unit 56 supports slide unit 53. Pedestal unit 56 is fixed to the installation surface.

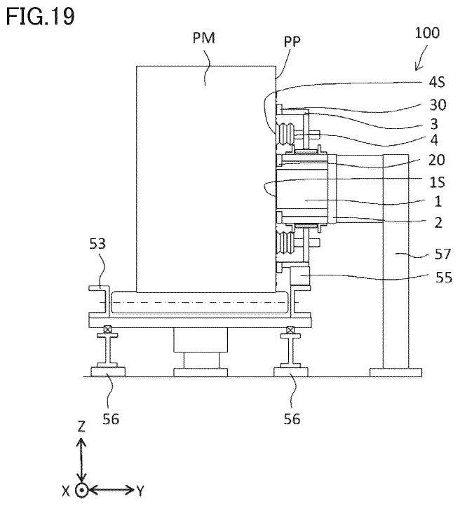

As shown in FIG. 19, printing apparatus 100 includes a drive unit 54. Drive unit 54 is fixed to the installation surface. Slide unit 53 is connected to drive unit 54. Pedestal unit 56 includes a pair of I-shaped (rotated H-shaped) support members. The pair of support members are disposed on both sides of drive unit 54. The pair of support members support both ends of slide unit 53. As a result, a load of slide unit 53 is distributed to drive unit 54 and the pair of support members.

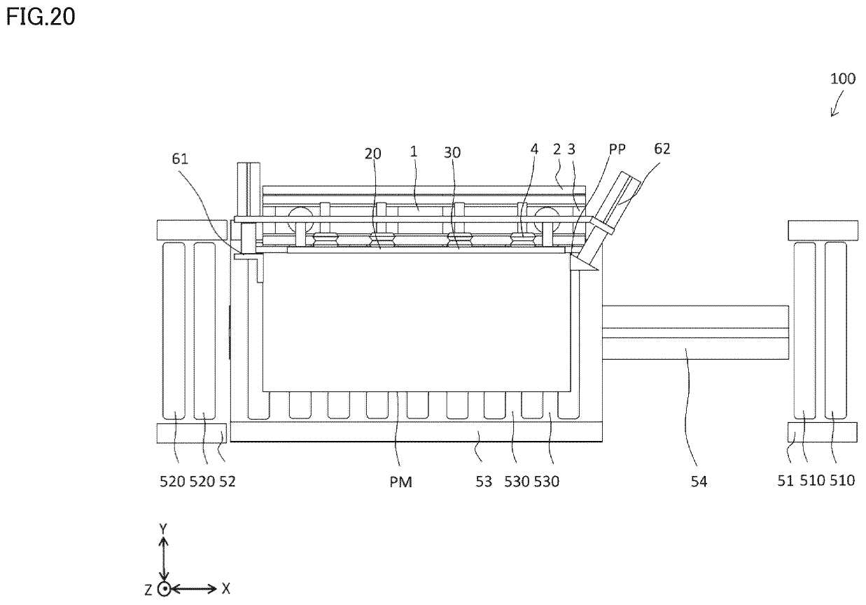

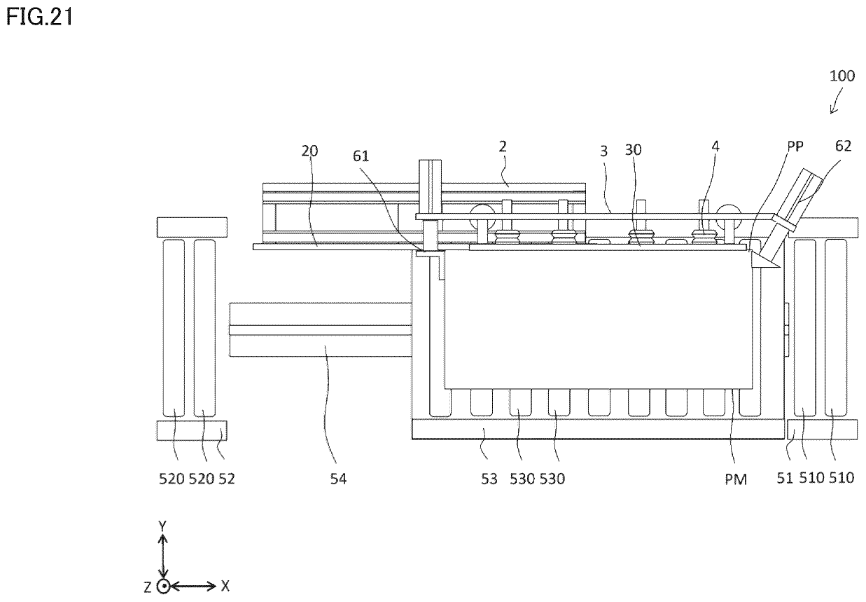

As shown in FIGS. 20 and 21, carry-in unit 51 includes a plurality of first roller units 510. The plurality of first roller units 510 rotate, whereby object to be printed PM disposed on the plurality of first roller units 510 is conveyed to slide unit 53. Carry-out unit 52 includes a plurality of second roller units 520. The plurality of second roller units 520 rotate, whereby object to be printed PM disposed on the plurality of second roller units 520 is conveyed. Slide unit 53 includes a plurality of third roller units 530. The plurality of third roller units 530 rotate, whereby object to be printed PM disposed on the plurality of third roller units 530 is conveyed from carry-in unit 51 to carry-out unit 52.

Drive unit 54 is configured to cause slide unit 53 to reciprocate between carry-in unit 51 and carry-out unit 52. Drive unit 54 is configured to move slide unit 53 along the second direction (X-axis direction). Slide unit 53, and connection unit 55 and movable unit 3 connected to slide unit 53 are configured to move on drive unit 54.

The operation of printing apparatus 100 according to the second embodiment will now be described with reference to FIGS. 18 to 22.

Object to be printed PM is disposed on carry-in unit 51 in advance (S1). As shown in FIG. 18, at a home position of printing apparatus 100, object to be printed PM is conveyed from carry-in unit 51 to slide unit 53. The whole of object to be printed PM is conveyed to slide unit 53 (S2). The home position of printing apparatus 100 refers to a state in which slide unit 53 is disposed on the carry-in unit 51 side.

Next, end face 4S of holding mechanism 4 holds surface to be printed PP of object to be printed PM (S3). As shown in FIG. 19, holding mechanism 4 moves from the front of fixing guide 20 and movable guide 30 to fixing guide 20 and movable guide 30 along the third direction (Y-axis direction) in a state where end face 4S is holding object to be printed PM (S4). As a result, positioning restriction is imposed on object to be printed PM.

As shown in FIGS. 20 and 21, reference unit 61 and the pressing unit that form vibration suppression unit 6 are actuated to sandwich object to be printed PM (S5). Drive unit 54 moves slide unit 53 from carry-in unit 51 to carry-out unit 52 in the state where holding mechanism 4 is holding surface to be printed PP. Since rotating unit 36 rotates along rail unit 26 (see FIG. 1), a distance between printing head 1 and surface to be printed PP is kept constant.

Third roller units 530 of slide unit 53 rotate, whereby object to be printed PM moves from the carry-in unit 51 side to printing head 1. Printing head 1 performs printing on surface to be printed PP of object to be printed PM that has been conveyed to the front of printing head 1 (S6).

After printing ends, the state in which reference unit 61 and the pressing unit that form vibration suppression unit 6 sandwich object to be printed PM is canceled (S7). End face 4S of holding mechanism 4 moves from fixing guide 20 and movable guide 30 to the front of fixing guide 20 and movable guide 30 along the third direction (Y-axis direction) (S8). As a result, the positioning restriction on object to be printed PM is removed.

Next, third roller units 530 of slide unit 53 rotate, whereby object to be printed PM is conveyed from printing head 1 to the carry-out unit 52 side. Next, holding mechanism 4 releases object to be printed PM (S9). Object to be printed PM released from holding mechanism 4 is conveyed to carry-out unit 52 by rotation of third roller units 530 of slide unit 53 (S10).

As described above, object to be printed PM is conveyed from carry-in unit 51 to a conveyance unit.

After object to be printed PM is conveyed to the conveyance unit, drive unit 54 conveys slide unit 53 from the carry-out unit 52 side to the conveyance unit side. As a result, printing apparatus 100 returns to the home position.

The function and effect of the present embodiment will now be described.

In printing apparatus 100 according to the second embodiment, as shown in FIGS. 17 and 18, movable unit 3 is configured to be capable of reciprocating between carry-in unit 51 and carry-out unit 52. Therefore, movable unit 3 can move from carry-in unit 51 to carry-out unit 52. Thus, printing apparatus 100 can perform printing on object to be printed PM that is conveyed from carry-in unit 51 to carry-out unit 52. Therefore, printing can be performed on object to be printed PM in the middle of the production process.

As shown in FIGS. 17 and 18, movable unit 3 is configured to be capable of reciprocating between carry-in unit 51 and carry-out unit 52. Therefore, movable unit 3 can move from carry-out unit 52 to carry-in unit 51. Thus, after object to be printed PM on which printing has been performed between carry-in unit 51 and carry-out unit 52 is conveyed to carry-out unit 52, printing can be performed on another object to be printed PM. As a result, holding mechanism 4 can be repeatedly used between carry-in unit 51 and carry-out unit 52. Therefore, an increase in cost of printing apparatus 100 can be reduced.

As shown in FIGS. 20 and 21, the plurality of third roller units 530 of slide unit 53 rotate, whereby object to be printed PM disposed on the plurality of third roller units 530 is conveyed from carry-in unit 51 to carry-out unit 52. Therefore, even when there is no drive source for moving object to be printed PM to the preceding step and the subsequent step, object to be printed PM can be moved.

As shown in FIG. 19, end face 4S of holding mechanism 4 is configured to move surface to be printed PP from the front of printing head 1 to printing head 1 along the third direction (Y-axis direction). Therefore, the conveyor does not need to move surface to be printed PP to printing head 1. This eliminates the need to incline the conveyor such that surface to be printed PP moves from the front of printing head 1 to printing surface 1S, for example. Therefore, the structure of the conveyor can be simplified.

As shown in FIGS. 20 and 21, drive unit 54 is configured to move slide unit 53 along the second direction (X-axis direction). Therefore, precision movement of slide unit 53 disposed on drive unit 54 can be achieved by drive unit 54. Since the precision movement in the second direction (X-axis direction) can be achieved, the timing of printing on object to be printed PM can be synchronized with the speed of drive unit 54. In addition, slide unit 53 can be stopped in the middle of conveyance of object to be printed PM. In addition, the conveyance speed of slide unit 53 can be controlled.

As shown in FIG. 18, fixing unit 2 is fixed to the installation surface by pillar unit 57 at the position distant from the installation surface. Therefore, printing head 1 is fixed to fixing unit 2 at the position distant from the installation surface. As a result, printing head 1 can be used in a static environment where printing head 1 does not move with respect to fixing unit 2 and the installation surface. In addition, maintenance of printing head 1 can be performed more easily, as compared with when printing head 1 is incorporated into the conveyance facility.

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 printing head; 1S printing surface; 2 fixing unit; 3 movable unit; 4 holding mechanism; 4S end face; 6 vibration suppression unit; 20 fixing guide; 21 first fixing guide unit; 22 second fixing guide unit; 30 movable guide; 31 first movable guide unit; 32 second movable guide unit; 41 first holding unit; 42 second holding unit; 51 carry-in unit; 52 carry-out unit; 61 reference unit (vibration suppression unit); 62 pressing unit (vibration suppression unit); 63 abutting unit; 64 shaft unit; 65 abutting unit; 66 shaft unit; 100 printing apparatus; 410 first holding part; 420 second holding part; 611 first reference unit; 612 second reference unit; 621 first pressing unit; 622 second pressing unit; PM object to be printed.

1. A printing apparatus comprising:
a printing head having a printing surface;
a fixing unit connected to the printing head and having a fixing guide disposed along a first direction including the printing surface;
a movable unit connected to the fixing unit, having a movable guide disposed along the first direction, and being movable with respect to the printing head along a second direction, the second direction intersecting with the first direction;
a holding mechanism disposed on the movable unit and holding an object to be printed along the first direction, the object to be printed being an object on which printing by the printing head is performed; and
a vibration suppression unit disposed at the movable unit and holding the object to be printed along the second direction.

2. The printing apparatus according to claim 1, wherein
the vibration suppression unit is disposed at both ends of the movable unit.

3. The printing apparatus according to claim 1, wherein
the vibration suppression unit comprises a plurality of vibration suppression units, and
the vibration suppression units disposed at both ends of the movable unit have different shapes.

4. The printing apparatus according to claim
1, wherein
the holding mechanism is movable from the front of the fixing guide and the movable guide to the fixing guide and the movable guide along a third direction, the third direction intersecting with each of the first direction and the second direction.

5. The printing apparatus according to claim 4, wherein
the holding mechanism is configured to be capable of moving an end face of the holding mechanism by being extended and contracted along the third direction.

6. The printing apparatus according to claim
1, wherein
the printing head is fixed to the fixing unit.

7. The printing apparatus according to claim
1, further comprising:
a carry-in unit to convey the object to be printed to the movable unit; and
a carry-out unit to receive the object to be printed that has been conveyed by the movable unit, wherein
the movable unit carries, to the carry-out unit, the object to be printed that has been conveyed by the carry-in unit.

8. The printing apparatus according to claim 1, wherein
the vibration suppression unit is disposed at an end of the movable unit.
